(19) United States
(12) Patent Application Publication
(10) Pub. No.: US 2012/0284111 A1
(43) Pub. Date: Nov. 8, 2012

(54) MULTI-METRIC TRENDING STORYBOARD

(75) Inventors: Yun Shi, Redmond, WA (US); Haik E. Babaian, Issaquah, WA (US); Dong Chen, Issaquah, WA (US); Anand Edwin, Bellevue, WA (US)

(73) Assignee: MICROSOFT CORPORATION, Redmond, WA (US)

(21) Appl. No.: 13/098,794

(22) Filed: May 2, 2011

(51) Int. Cl. G06Q 30/00

(52) U.S. Cl. 705/14.41

(57) ABSTRACT

A graphical user interface for displaying internet advertising metrics and comparisons of internet advertising metrics is provided. The graphical user interface comprises a trending display area that displays a plurality of trending graphs in the same viewable area. Each trending graph displays a different internet advertising metric and is configured to display a plurality of internet advertising trending comparisons. As well, a detail display area displays a detail view of at least one of the trending graphs. The detail view is in the same viewable area as the plurality of trending graphs.

### BACKGROUND

For online advertisers, advertising campaign trending information is vitally important. But graphic displays of internet advertising metrics associated with an advertising campaign are frequently limited to one or two metrics within the same viewable area because of screen size constraints. If the advertiser desires to see additional metrics in graphic form, it is often at the expense of one of the metrics currently being viewed. Thus, it is difficult for the advertiser to gain a comprehensive view of how well, for example, a particular advertising campaign is doing across a multiple of different internet advertising metrics.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, presenting a graphical user interface that allows a user to view multiple metrics related to a discrete subject matter at a time. This is useful across a broad spectrum of fields. For example, a person in the financial field would like to view multiple financial metrics at the same time such as cost, spend, return on investment, and the like. More specifically, the present invention enables an advertiser to view multiple internet advertising metrics related to an advertising campaign at the same time. Each metric is displayed on a trending graph, and the trending graphs are arranged to facilitate comparisons between the metrics. In addition, a detail view of at least one of the trending graphs can be displayed simultaneously with the trending graphs. Each trending graph may also be configured to display a plurality of internet advertising trending comparisons.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system suitable for generating a graphical user interface for displaying internet advertising metrics, in accordance with an embodiment of the present invention; and

FIGS. 3-6 depict exemplary graphical user interfaces for displaying trending information related to internet advertising metrics, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-readable media for, among other things, generating and displaying graphical user interfaces (GUIs) that allow a user to view multiple metrics related to a discrete subject matter at a time. This is useful across a broad spectrum of fields. For example, a person in the financial field would like to view multiple financial metrics at the same time such as cost, spend, return on investment, and the like. More specifically, the present invention enables advertisers to visually compare different internet advertising metrics for a particular advertising campaign. Each metric is displayed on a trending graph, and the trending graphs are arranged to facilitate comparison between the metrics. In addition, a detail view of one of the trending graphs can be displayed simultaneously with the trending graphs. Each trending graph may also be configured to display a plurality of internet advertising trending comparisons.

Accordingly, in one embodiment, the present invention is directed toward a GUI for displaying internet advertising metrics, stored on computer-readable media and executable by a computing device. The GUI comprises a trending display area that displays a first set of trending graphs in the same viewable area. Each trending graph displays a different online advertising metric. A detail display area displays a detail view of at least one of the trending graphs in the first set of trending graphs. The detail view is in the same viewable area as the first set of trending graphs. Additionally, an addition area enables a user to select and display additional internet advertising metrics on a second set of trending graphs. The second set of trending graphs is displayed simultaneously and in the same viewable area as the detail view and the first set of trending graphs.

In another embodiment, the present invention is directed toward a GUI for displaying trending information related to internet advertising metrics, stored on computer-readable media and executable by a computing device. The GUI comprises a trending display area that displays a plurality of trending graphs in the same viewable area. Each trending graph displays a different internet advertising metric and is also configured to display a plurality of internet advertising trending comparisons. In addition, a detail display area displays a detail view of at least one of the trending graphs; the detail view is in the same viewable area as the plurality of trending graphs.

In yet another embodiment, the present invention is directed to a GUI for displaying in the same viewable area a plurality of internet advertising metrics, stored on computer-readable media and executable by a computing device. The GUI comprises a trending display area that displays trending relationships between a plurality of trending graphs. Each trending graph displays a different internet advertising metric and, as well, can display a plurality of internet advertising trending comparisons. A detail display area displays a detail view of at least one of the trending graphs where the detail view occupies a greater proportion of the viewable area compared to the plurality of trending graphs. An addition area enables a user to select and display additional trending graphs.

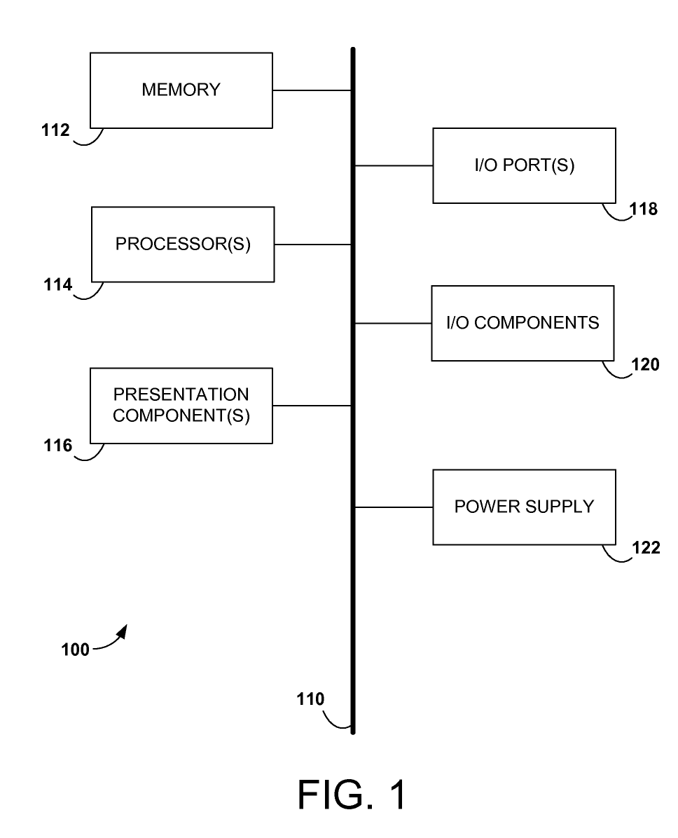

An exemplary computing environment suitable for use in implementing embodiments of the present invention is described below in order to provide a general context for various aspects of the present invention. Referring to FIG. 1, such an exemplary computing environment is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, I/O components 120, and an illustrative power supply 122. The bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

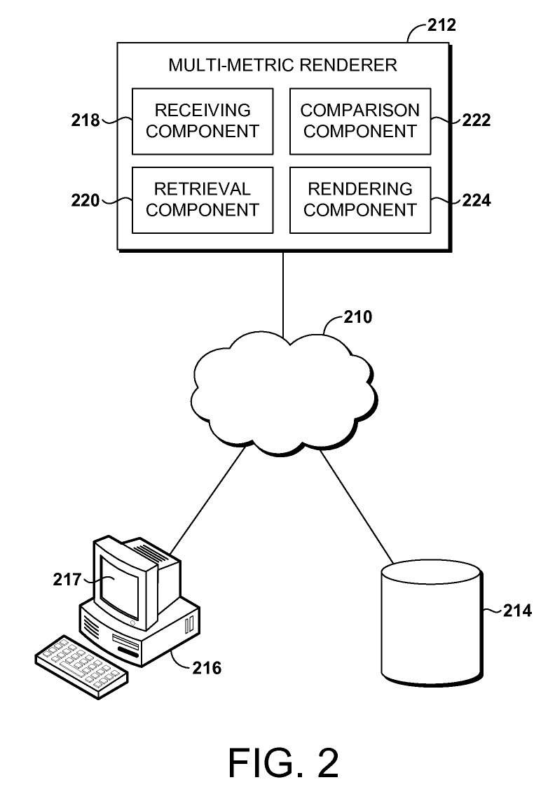

Turning now to FIG. 2, a block diagram is illustrated that shows an exemplary computing system environment 200 suitable for use in implementing embodiments of the present invention. It will be understood and appreciated that the computing system environment 200 shown in FIG. 2 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a multi-metric renderer 212, a data store 214, and an end-user computing device 216 with a display screen 217 all in communication with one another via a network 210. The network 210 may include, without limitation, one or more local area networks (LANs) and/or wide area networks (WANs). Such networking environments are commonplace in offices, enterprise-wide computer networks, intranets and the Internet. Accordingly, the network 210 is not further described herein.

In some embodiments, one or more of the illustrated components/modules may be implemented as stand-alone applications. In other embodiments, one or more of the illustrated components/modules may be integrated directly into the operating system of the multi-metric renderer 212. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers, search engine computing devices, or the like. By way of example only, the multi-metric renderer 212 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 214 is configured to store information associated with internet advertising. In various embodiments, such information may include, without limitation, information concerning internet advertisers and their internet advertisement campaigns, internet advertising metrics associated with the advertisement campaigns, information on advertisement industry benchmarks, internet search engines, and/or the like. In embodiments, the data store 214 is configured to be searchable for one or more of the items stored in association therewith. The information stored in association with the data store 214 may be configurable and may include any information relevant to advertisers, advertisement campaigns, internet advertising metrics, internet search engines, and/or the like. The content and volume of such information are not intended to limit the scope of embodiments of the present invention in any way. Further, though illustrated as a single, independent component, the data store 214 may, in fact, be a plurality of storage devices, for instance, a database cluster, portions of which may reside on the multi-metric renderer 212, end-user computing device 216, and/or any combination thereof.

The multi-metric renderer 212 shown in FIG. 2 may be any type of computing device, such as, for example, computing device 100 described above with reference to FIG. 1. By way of example only and not limitation, the multi-metric renderer 212 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

As shown, the end-user computing device 216 includes a display screen 217. The display screen 217 is configured to display information to the user of the end-user computing device 216, for instance, information relevant to communications initiated by and/or received by the end-user computing device 216, information concerning internet advertising metrics, graphical displays of internet advertising metrics, and/or the like. Embodiments are not intended to be limited to visual display but rather may also include audio presentation, combined audio/visual presentation, and the like. The end-user computing device 216 may be any type of display device suitable for presenting a GUI. Such computing devices may include, without limitation, a computer, such as, for example, computing device 100 described above with reference to FIG. 1. Other types of display devices may include tablet PCs, PDAs, mobile phones, smart phones, as well as conventional display devices such as televisions.

Components of the multi-metric renderer 212 may include, without limitation, a processing unit, internal system memory, and a suitable system bus for coupling various system components, including one or more data stores for storing information (e.g., files and metadata associated therewith). The multi-metric renderer 212 typically includes, or has access to, a variety of computer-readable media. By way of example, and not limitation, computer-readable media may include computer-storage media and communication media. In general, communication media enables each computing device to exchange data via a network, e.g., network 210. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computing system environment 200 is merely exemplary. While the multi-metric renderer 212 is illustrated as a single unit, one skilled in the art will appreciate that the multi-metric renderer 212 is scalable. For example, the multi-metric renderer 212 may in actuality include a plurality of computing devices in communication with one another. Moreover, the data store 214, or portions thereof, may be included within, for instance, the multi-metric renderer 212, a search engine, or a third-party service as a computer-storage medium. The single unit depictions are meant for clarity, not to limit the scope of embodiments in any form.

As shown in FIG. 2, the multi-metric renderer 212 comprises a receiving component 218, a retrieval component 220, a comparison component 222, and a rendering component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the computing device 100 of FIG. 1. It will be understood by those of ordinary skill in the art that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 is configured to receive (via the network 210) requests from a user (typically an advertiser) for a graphical representation(s) of internet advertising metrics associated with, for example, a particular advertising campaign associated with the advertiser. The receiving component 218 may also receive other user requests regarding the graphical representations. For example, the user may request that certain filters be applied to the internet advertising metrics. Such user-requested filters may include no filter, search traffic only, content traffic only, active campaigns, active keywords, best performing keywords, keywords with no-clicks, expensive keywords, and the like. In addition, the user can create custom filters that can be selected and applied to the internet advertising metrics.

The receiving component 218 may also receive request from the user that the internet advertising metrics be sampled over a specified range of time. For example, the user may request that the advertising metrics be sampled only for today, yesterday, the last 7 days, the last 14 days, the last 30 days, month to date, last month, last 3 months, or the last 6 months. Continuing, the receiving component 218 may also receive requests from the user that certain types of comparisons be made using advertising metrics, or that graphical representations of additional internet advertising metrics be displayed. Any and all such variations, and any combination thereof, are contemplated to be within the scope of embodiments of the present invention.

The retrieval component 220 is configured to retrieve the requested internet advertising metrics. The retrieval component may, for example, retrieve the internet advertising metrics from the data store 214. Internet advertising metrics include a variety of well-known metrics that measure the effectiveness of an internet advertisement campaign. For example, internet advertising metrics may include impressions, clicks, spend, conversions, average position, average cost per click, click through rate, cost per action, cost per click, conversion rate, percentage of change, and the like. There are many examples of metrics used to measure the effectiveness of internet advertising and these are all included within the scope of the invention.

The comparison component 222 is configured to perform user-requested comparisons utilizing internet advertising metrics. Such comparisons may include comparisons of internet advertising metrics over a plurality of different time periods, comparisons of internet advertising metrics for a plurality of different advertisement campaigns, comparisons of internet advertising metrics for a particular advertising campaign across a plurality of different search engines, or comparisons of internet advertising metrics for a particular advertising campaign with industry benchmarks. Other examples include comparisons of internet advertising metrics for a particular advertising campaign with a plurality of internet advertising metrics associated with a competitor of the user, or comparisons of internet advertising metrics for a particular advertising campaign with advertising metrics for previous advertisement campaigns. Any and all such variations, and any combination thereof, are contemplated to be within the scope of embodiments of the present invention.

The rendering component 224 is configured to render a GUI that displays graphical representations of internet advertising metrics in the same viewable area. In one aspect, the rendering component 224 utilizes information from the receiving component 218, the retrieval component 220, and the comparison component 222 to generate a GUI uniquely tailored to the needs of a user. In another aspect, the rendering component 224 determines the amount of screen real estate available on a display device and resizes the graphical representations so that they effectively occupy the available screen space and are all visible within the same viewable area. In other words, it may not be necessary to use a browser scroll bar to view all of the graphical representations.

In yet another aspect, the rendering component 224 may determine that the screen width of a display device has changed. For example, a user may have switched from viewing the display screen of a personal computer to viewing the display screen of a smart phone. Upon making such a determination, the rendering component 224 may proportionally change the size of the graphical representations so that all of the representations continue to be in the same viewable area.

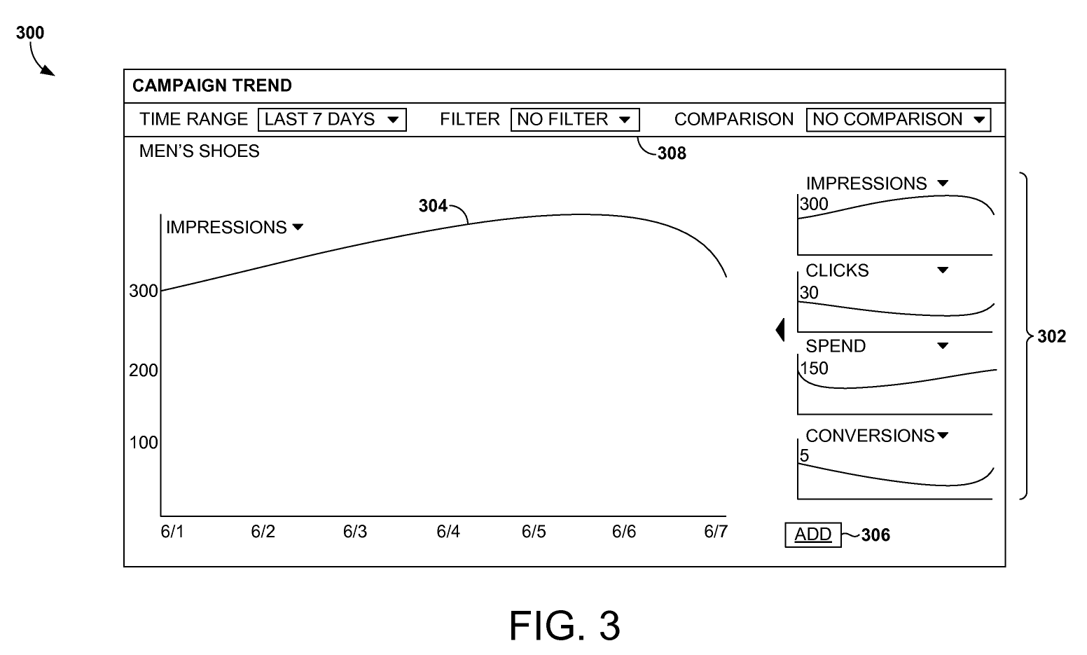

Turning now to FIG. 3, a graphical user interface (GUI) for displaying trending information related to a plurality of internet advertising metrics is depicted and is referenced generally by the numeral 300. A trending display area 302 displays a first set of trending graphs in the same viewable area. Each trending graph displays a different internet advertising metric. The trending graphs, in one aspect, are in the form of line graphs with each graph having an x-axis and a y-axis. Parameters associated with an internet advertising metric are represented on the y-axis, and time is represented on the x-axis. The time range displayed on each trending graphs is identical. For example, if trending graph 1 covers a time range of seven days, then trending graphs 2, 3, and 4 will display the same time range. Still further, in one aspect, only the y-intercept parameter is actually visible to the user.

Continuing on with respect to the trending display area 302, the trending graphs may be vertically aligned with each other to better facilitate the visualization of trending information using the different internet advertising metrics. The utilization of identical time ranges on the x-axis augments the visualization of this trending information. In one aspect, the first set of trending graphs includes four trending graphs that display internet advertising metrics related to impressions, clicks, spend, and conversions.

A detail display area 304 displays a detail view of at least one trending graph in the first set of trending graphs. The detail view is in the same viewable area as the first set of trending graphs. In one aspect, the detail view is instantiated when a user hovers over the at least one trending graph. The concept of hovering over an object on a display screen to initiate an action is well-known and will not be explained further. In other aspects, the detail view is instantiated by clicking on the desired trending graphs, issuing a voice command, employing gesture recognition technology, and/or the like. Any and all such variations, and any combination thereof, are contemplated to be within the scope of embodiments of the present invention.

In one aspect, the detail view occupies a greater proportion of the viewable area as compared to the first set of trending graphs. In yet another aspect, the detail view is located adjacent to the first set of vertically-aligned trending graphs as depicted in FIG. 3. This arrangement allows the user to simultaneously see the “big picture” in the form of the trending graphs along with more detailed information regarding a particular internet advertising metric. As can be seen from FIG. 3, the detail view provides a larger and more detailed view of the selected trending graph. Thus, the actual values associated with the x-axis and the y-axis are displayed. Further, in an additional aspect, the detail view can be collapsed or hidden and, if desired, another detail view can be selected of a different internet advertising metric.

An addition area 306 enables a user to select and display additional internet advertising metrics to be displayed on a second set of trending graphs. The second set of trending graphs can be displayed simultaneously with the first set of trending graphs and in the same viewable area as the detail view and the first set of trending graphs. The additional internet advertising metrics were discussed above with respect to FIG. 2, but will be outlined again. They include: average position, average cost per click, click through rate, cost per action, cost per click, conversion rate, percentage of change, and the like. The second set of trending graphs may be aligned vertically with the first set of trending graphs to further facilitate visualization of trending information. In addition, a detail view can be instantiated from any of the trending graphs in the second set of trending graphs by utilizing the methods outlined above.

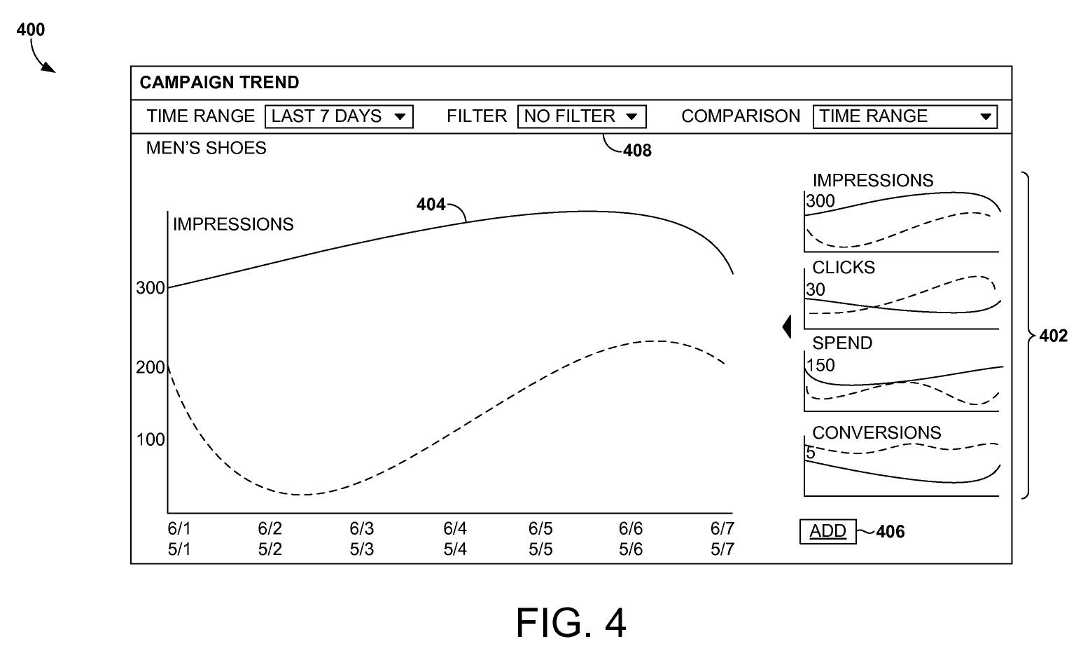

A user control area 308 enables a user to select a time or date range. The internet advertising metrics are then sampled and displayed over the selected time range. In addition, the user control area 308 also enables the user to select different filters to be applied to the internet advertising metrics. By way of illustrative example, a user may request that internet advertising metrics be displayed for, e.g., best performing keywords. Thus, clicks, conversions, impressions, and spend metrics are displayed for best performing keywords. In another example, a user may request that metrics related to search content for a particular advertising campaign be displayed. Other types of filters include: no filter, content traffic only, active campaigns, active keywords, worst performing keywords, keywords with no clicks, expensive keywords, competitive keywords, and the like. In addition, a user may create and apply a custom filter. Any and all such variations, and any combination thereof, are contemplated to be within the scope of embodiments of the present invention. The user control area 308 also enables a user to select a comparison metric to be applied to the trending graphs and the detail graph. This aspect will be detailed in greater depth below with respect to FIG. 4.

Turning now to FIG. 4, a graphical user interface (GUI) for displaying trending information related to a plurality of internet advertising metrics is depicted and is referenced generally by the numeral 400. GUI 400 shares many of the same features as GUI 300 such as a trending display area 402, a detail display area 404, an addition area 406, and a user control area 408. However, in this aspect, the trending graphs in the trending display area 402 and the detail graph in the detail display area 404 are displaying internet advertising comparisons. For example, the trending graphs are displaying a comparison of internet advertising metrics over two different time periods (last 7 days compared to a 7 day period starting May 1, 2010). Each time period is represented by a line (solid and dashed). In this case, the internet advertising metrics relate to an advertising campaign involving men's shoes. As outlined above, the detail graph in the detail display area 404 is displaying a detailed view of at least one of the trending graphs.

The user control area 408 enables a user to select the type of comparison to be displayed by the trending graphs and/or the detail view. In one aspect, only one type of comparison is displayed at a time. For example, and as mentioned above, a user may choose to compare internet advertising metrics over a plurality of different time periods, for a plurality of different advertisement campaigns, or for a particular advertising campaign across a plurality of different search engines. In addition, internet advertising metrics for a particular advertising campaign can be compared with internet advertising metrics associated with a competitor of the user, or a comparison can be made between internet advertising metrics for a particular advertising campaign and industry benchmarks. An additional example includes comparing internet advertising metrics for a particular advertising campaign with advertising metrics for previous advertisement campaigns. Any and all such variations, and any combination thereof, are contemplated to be within the scope of embodiments of the present invention.

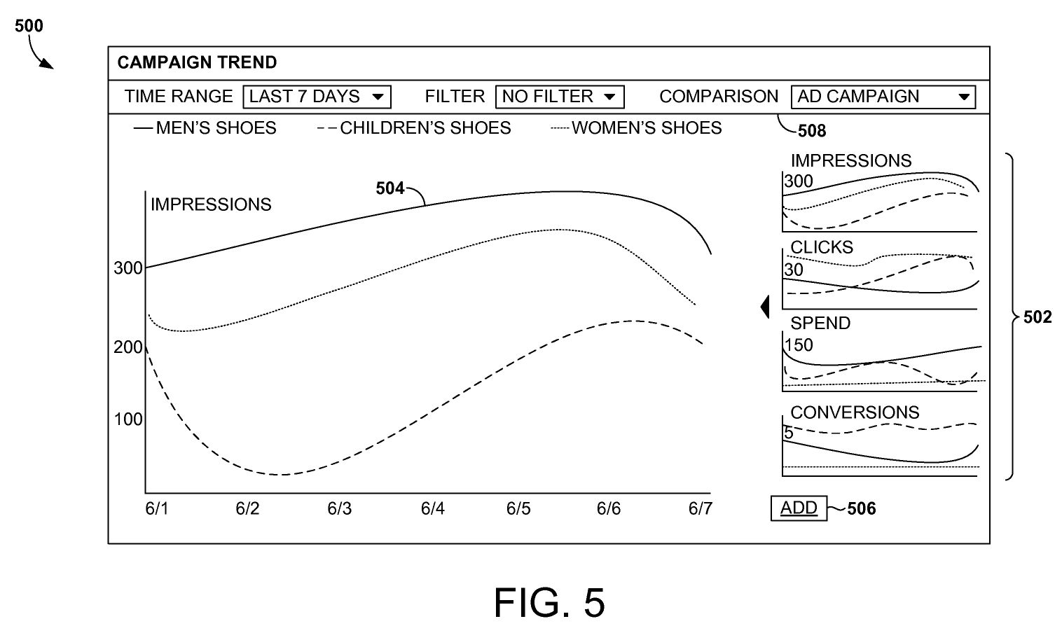

FIG. 5, referenced by the numeral 500, is an example of a GUI displaying a different type of comparison. Like FIGS. 3 and 4, FIG. 5 has a trending display area 502, a detail display area 504, an addition area 506, and a user control area 508. As can be seen from the user control area 508, a user has selected a comparison of different advertising campaigns (men's shoes, women's shoes, and children's shoes). The trending graphs can display multiple parameters associated with a single comparison. For example, internet advertising metrics for a plurality of search engines can be displayed on a trending graph, or multiple time ranges can be compared on a trending graph. Each parameter is associated with a different line characteristic (solid, dashed, dotted, etc.). Any and all such variations, and any combination thereof, are contemplated to be within the scope of embodiments of the present invention.

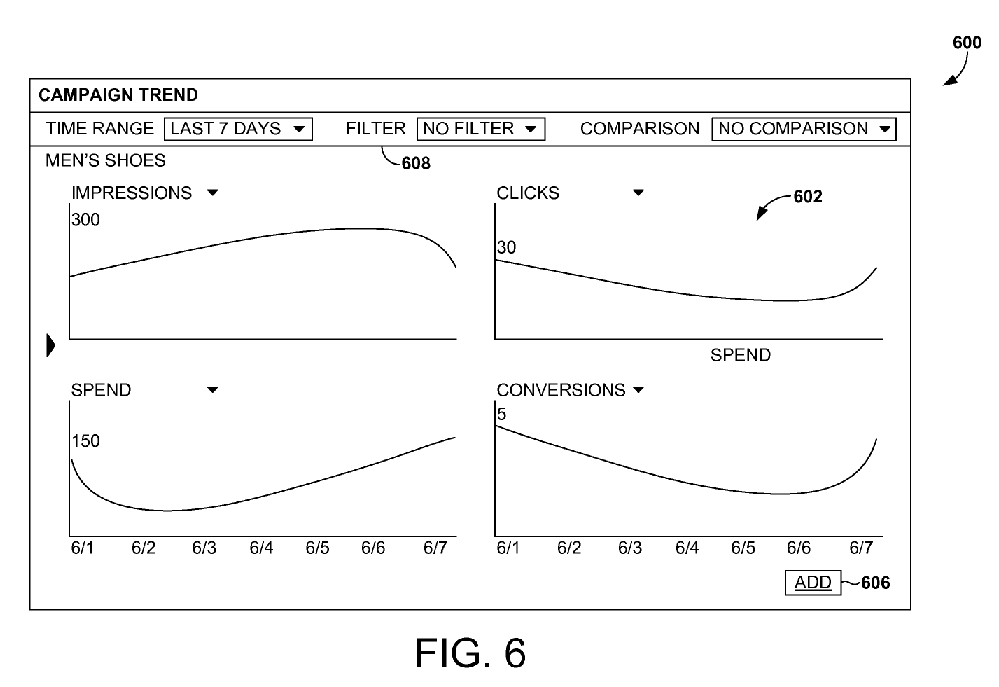

FIG. 6 depicts a GUI, referenced generally by the numeral 600, in another embodiment of the invention. As before, there is an addition area 606 and a user control area 608. But in this aspect, a trending display area 602 occupies almost the entire viewable area. Four trending graphs are depicted with two of the trending graphs aligned vertically and adjacent to another set of two, vertically aligned trending graphs. As can be seen, the x-axes of the trending graphs located at the bottom of the viewable area have date parameters explicitly shown. In one aspect, a user can perform a user action with respect to at least one of the trending graphs and instantiate a detail view (not shown). In this case, GUI 600 would change to a view similar to GUI 300 shown in FIG. 3.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. A graphical user interface for displaying internet advertising metrics, stored on one or more computer-readable media and executable by a computing device, the graphical user interface comprising:
a trending display area configured to display a first set of trending graphs in the same viewable area, each trending graph displaying a different internet advertising metric;
a detail display area configured to display a detail view of at least one trending graph in the first set of trending graphs, the detail view in the same viewable area as the first set of trending graphs; and
an addition area, the addition area enabling a user to select and display additional internet advertising metrics to be displayed on a second set of trending graphs, the second set of trending graphs being displayed simultaneously with the first set of trending graphs and in the same viewable area as the first set of trending graphs and the detail view.

2. The graphical user interface of claim 1, the graphical user interface further comprising a user control area, the user selection area comprising:
a time range selection area; and
a filter selection area.

3. The graphical user interface of claim 2, wherein the time range selection area enables a user to select time periods for sampling the internet advertising metrics, wherein the time periods include: today, yesterday, last 7 days, last 14 days, last 30 days, month to date, last month, last 3 months, or last 6 months.

4. The graphical user interface of claim 1, wherein the first set of trending graphs includes four trending graphs.

5. The graphical user interface of claim 4, wherein the internet advertising metrics displayed on the first set of trending graphs include impressions, clicks, spend, and conversions.

6. The graphical user interface of claim 1, wherein the first set of trending graphs are vertically aligned with each other.

7. The graphical user interface of claim 1, wherein the first set of trending graphs and the second set of trending graphs are line graphs.

8. The graphical user interface of claim 1, wherein the detail display area is configured to display a detail view of at least one trending graph in the second set of trending graphs.

9. The graphical user interface of claim 8, wherein a mouse hover over the at least one trending graph of the first or second set of trending graphs instantiates a detail view of the at least one trending graph.

10. The graphical user interface of claim 1, wherein the additional internet advertising metrics displayed on the second set of trending graphs comprise: average position, average cost per click, click through rate, cost per action, cost per click, conversion rate, or percentage of change.

11. The graphical user interface of claim 2, wherein the filter selection area enables a user to select at least one filter to apply to the first and second set of trending graphs, wherein the filter comprises: no filter, search traffic only, content traffic only, active campaigns, active keywords, best performing keywords, worst performing keywords, keywords with no clicks, expensive keywords, competitive keywords, or user-customized filters.

12. A graphical user interface for displaying trending information related to internet advertising metrics, stored on one or more computer-readable media and executable by a computing device, the graphical user interface comprising:
a trending display area configured to display a plurality of trending graphs in the same viewable area, each trending graph displaying a different internet advertising metric and each trending graph configured to display a plurality of internet advertising trending comparisons; and
a detail display area configured to display a detail view of at least one of the trending graphs, the detail view in the same viewable area as the plurality of trending graphs.

13. The graphical user interface of claim 12, the graphical user interface further comprising a user control area, the user control area enabling a user to select a type of internet advertising trending comparison to be displayed on the plurality of trending graphs.

14. The graphical user interface of claim 13, wherein only one type of internet advertising trending comparison is displayed at a time.

15. The graphical user interface of claim 14, wherein the type of internet advertising trending comparison comprises:
(A) comparisons of internet advertising metrics over a plurality of different time periods,
(B) comparisons of internet advertising metrics for a plurality of different advertisement campaigns,
(C) comparisons of internet advertising metrics for a particular advertising campaign across a plurality of different search engines,
(D) comparisons of internet advertising metrics for a particular advertising campaign with a plurality of industry benchmarks, or
(E) comparisons of internet advertising metrics for a particular advertising campaign with a plurality of internet advertising metrics associated with a competitor of the user.

16. A graphical user interface for displaying in the same viewable area a plurality of internet advertising metrics, stored on one or more computer-readable media and executable by a computing device, the graphic user interface comprising:
a trending display area configured to display trending relationships between a plurality of trending graphs, each trending graph displaying a different internet advertising metric, and each trending graph configured to display a plurality of internet advertising trending comparisons;
a detail display area configured to display a detail view of at least one of the trending graphs, wherein the detail display area occupies a greater proportion of the viewable area as compared to the plurality of trending graphs; and
an addition area, the addition area enabling a user to select and display additional trending graphs.

17. The graphical user interface of claim 16, wherein the detail view of the at least one of the trending graphs is displayed simultaneously with the at least one of the trending graphs.

18. The graphical user interface of claim 16, wherein the detail view of the at least one of the trending graphs includes x-axis parameters and y-axis parameters.

19. The graphical user interface of claim 16, wherein the plurality of trending graphs are vertically aligned, and the detail view is adjacent to the plurality of trending graphs.

20. The graphical user interface of claim 16, wherein each trending graph displays a different internet advertising metric over the same time range.
